(19) United States
(12) Patent Application Publication
(10) Pub. No.: US 2006/0162687 A1
(43) Pub. Date: Jul. 27, 2006

(54) Engine induction system

(76) Inventor: Michael A. Amburgy, Warren, MI (US)

Correspondence Address: LITMAN LAW OFFICES, LTD, PO BOX 15035, CRYSTAL CITY STATION, ARLINGTON, VA, 22215, US

(21) Appl. No.: 11/331,050

(22) Filed: Jan. 13, 2006

Related U.S. Application Data
(60) Provisional application No. 60/646,984, filed on Jan. 27, 2005.

(51) Int. Cl. F02M 35/04

(52) U.S. Cl. 123/198 E

(57) ABSTRACT

The engine induction system is a supplemental air filtration system for internal combustion engines. The system adds one or more supplemental air filter elements providing parallel flow with the original filter element, thus allowing air to flow through all filters simultaneously, rather than sequentially as in progressive filter systems. Thus, the system continues to allow air to flow into the induction system through other filters if a single filter becomes blocked. The system may have one or more supplemental filters connected to the primary filter plenum via appropriate ductwork, allowing the supplemental filters to be located in any practicable location as desired. Alternatively, one or more filters may be connected directly or remotely to the endplate of a cylindrical or conical filter element. The result is an increase in overall filtration area and a reduced pressure drop across the filters and corresponding increase in engine efficiency.

### CROSS-REFERENCE TO RELATED APPLICATION

This application claims the benefit of U.S. Provisional Patent Application Ser. No. 60/646,984, filed Jan. 27, 2005.

### BACKGROUND OF THE INVENTION

1. Field of the Invention

The present invention relates generally to air induction systems for internal combustion engines. More specifically, the induction system incorporates multiple air filters in parallel with one another and with the primary filter of the system in order to provide greater airflow for more efficient engine operation.

2. Description of the Related Art

All internal combustion engines rely upon the basic principle of taking in oxygen, burning the oxygen with fuel in one or more combustion chambers, and expelling the exhaust. Conventionally, the oxygen is provided with atmospheric air drawn into the engine through an induction system or intake manifold. The intake air is nearly always filtered in order to avoid abrasion damage due to the extremely close tolerance components within the combustion chamber(s) and cylinder(s) of the engine.

One of the major limitations of the power output of an engine is the volume of air (and therefore oxygen) that can be drawn into the engine through the intake system. Normally aspirated engines are limited not only by the volumetric efficiency of the engine, but also by frictional losses in the intake system comprising the intake manifold, fuel metering system, and air filtration system. While supercharged engines overcome losses due to volumetric efficiency, they are still subject to airflow restrictions due to losses across the air filter(s) of the induction system.

Engine and air filter manufacturers are pulled between two opposing requirements when designing filtration systems for engine induction systems. It is desirable to provide minimal airflow restriction and pressure drop across the filter, for the reasons noted above. However, it is also critical that the filter do a good job of filtering out even the smallest particles, which may damage the internal components of the engine. Obviously, the least restrictive system is one with no filtration at all, which is not practicable due to the resulting short life span of an engine so equipped. Manufacturers must provide good air filtration for their engines in order for the engines to survive for relatively long periods, avoid warranty claims, and generally develop a good reputation for the manufacturer. Accordingly, manufacturers tend to install air filters that filter out the smallest airborne particles practicable. However, such filters are relatively restrictive to the inlet airflow for the engine, resulting in relatively high pumping losses through the induction system and resulting losses in efficiency.

Thus, an engine induction system solving the aforementioned problems is desired.

### SUMMARY OF THE INVENTION

The engine induction system is a multiple air filter system in which all filters are disposed in parallel with one another. Thus, all filters of the present system are independent of one another, and blockage of a single filter element has no effect on other filter elements or upon the remainder of the induction system, other than some slight increase in restriction to the overall system. The supplemental filter elements of the present system are connected to the engine induction system downstream of, or independently of, the primary filter element, thus placing the primary filter element in parallel with the supplementary filter elements.

One embodiment of the present system comprises one or more supplementary filter elements installed remotely from the primary filter plenum and connected thereto by appropriate tubing or ductwork, as required. The supplemental filter(s) may be placed in any practicable position as desired, e.g., just outside the engine compartment, where they receive cooler air for greater efficiency. Another embodiment of the system comprises the installation of a supplemental filter(s) directly upon the endplate of a cylindrical or conical filter element, thus serving to increase the overall surface area of the combined filter elements for less airflow restriction and greater efficiency. Any of the above embodiments may be provided in the form of an original installation, aftermarket installation, and/or in kit form for aftermarket installation upon a fixed or mobile internal combustion engine, as desired.

These and other features of the present invention will become readily apparent upon further review of the following specification and drawings.

### BRIEF DESCRIPTION OF THE DRAWINGS

FIG. 1 is a perspective view of a plurality of supplemental air filters connected to a primary air filter plenum according to a first embodiment of the present invention.

FIG. 2 is a perspective view of a plurality of elements comprising an exemplary kit for the present engine induction system.

FIG. 3 is an environmental perspective view of an alternative embodiment of an engine induction system according to the present invention installed on the intake system of an engine.

FIG. 4 is a schematic view of an exemplary system illustrating additional variations of an engine induction system according to the present invention.

Similar reference characters denote corresponding features consistently throughout the attached drawings.

### DETAILED DESCRIPTION OF THE PREFERRED EMBODIMENTS

The present invention is an engine induction system incorporating multiple air filters. Each embodiment of the system includes a single primary air filter and at least one supplemental, secondary air filter, with all filters being connected to an engine air induction plenum to provide simultaneous filtered airflow paths thereto. The additional filter elements result in increased filter surface area, thereby reducing the pressure drop across the filters for any given volume of air passing therethrough and increasing engine efficiency accordingly.

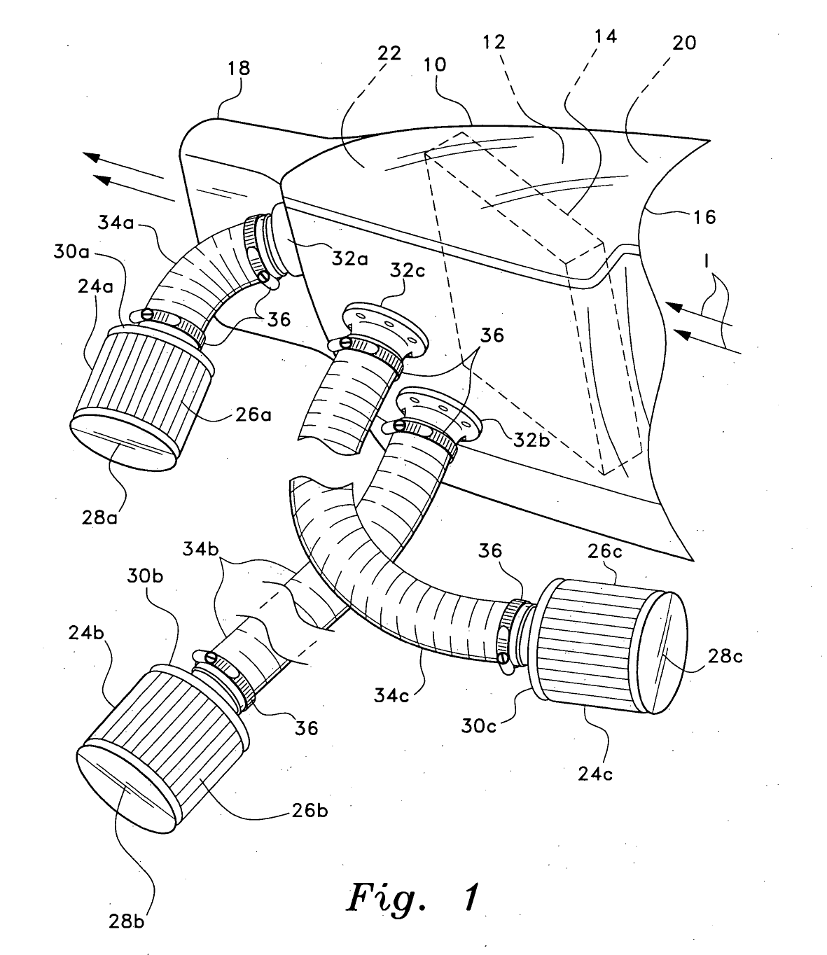

FIG. 1 of the drawings illustrates a first embodiment of the present system in which one or more supplemental, secondary filters are connected to the downstream side of an induction system plenum or housing. The internal chamber 12 or air passage of the air filter plenum 10 of FIG. 1 contains a single, flat primary filter element 14 therein (shown in broken lines in FIG. 1). Air inflow arrows I indicate airflow into the single inlet 16 (shown broken away due to sheet size limitations in FIG. 1), and air outflow arrows O represent airflow from the outlet end 18 of the plenum 10 to the engine (not shown in FIG. 1) after passing through the single primary filter element 14.

The primary filter element 14 is disposed generally centrally within the internal chamber 12 of the plenum 10, and divides the plenum cavity 12 into an inlet cavity 20 to the inlet side of the filter 14 and an opposite outlet cavity 22 to the outlet side of the filter 14. One or more supplemental, secondary filters, e.g., filters 24a, 24b, and 24c, generally as shown in FIG. 1, are disposed externally to the plenum 10 and connected to communicate with the outlet cavity 22 of the plenum 10 via suitable connections. The supplementary filters 24a through 24c may be of any suitable type, as desired. The exemplary supplementary filters 24a through 24c shown in FIG. 1 each have a generally toroidal configuration with a cylindrical exterior and hollow interior, the cylindrical sides being defined by the filter elements 26a through 26c themselves and the lengths being defined by closed ends 28a through 28c and opposite open outlet ends 30a through 30c which communicate with the primary filter plenum 10, as described below.

In the example of FIG. 1, a corresponding number of secondary inlet filter flanges or attachments 32a through 32c are secured to the outlet side of the plenum 10 and communicate with the outlet cavity 22 thereof. Each secondary filter attachment 32a through 32c has an elongate tube, respectively 34a through 34c, extending therefrom, to connect the corresponding filter element 24a through 24c to the outlet cavity 22 of the primary air filter plenum 10. The tubes 34a through 34c may be of any suitable configuration, so long as the tubes have gas impermeable walls to preclude the flow of air through their walls. In the example of FIG. 1, the tubes 34a through 34c are formed of flexible hose or duct, e.g., spiral wire reinforced SCAT tubing or the like. Such flexible hose or duct permits the supplemental inlet paths to be routed conveniently as desired. Alternatively, the connector tubes may be formed of rigid pipe or tubing, if so desired, in order to provide support for a supplementary filter at the distal end thereof. The hoses or tubes 34a through 34c are secured at each of their ends respectively to the corresponding necks of the supplementary filter outlet ends 30a through 30c and to the corresponding attachment fittings or flanges 32a through 32c installed on the outlet side of the plenum 10 by hose clamps 36 or other suitable securing means. The clamps 36 may include resilient takeup means, in order to apply a constant pressure to the underlying hose and tube ends regardless of expansion, contraction, and/or compression of those hose and tube ends.

The engine induction system embodiment of FIG. 1 serves to provide a significantly improved flow of air to the engine with which it is used, thereby significantly improving the efficiency of the engine operation. It will be noted that the surface area of each of the supplemental filters 24a through 24c is relatively large, due to the filter elements 26a through 26c extending about the complete circumference of each filter rather than being disposed in a flat plane, as in the case of the standard filter 14. This has the effect of increasing the total air filtration surface area by a factor of three or more, depending upon the size of the original filter 14 and the sizes and number of supplemental secondary filters used. The greatly increased filter surface area results in a significant reduction in restriction and pressure loss across the filter elements, thus reducing power required to overcome pumping losses in the engine to draw air into the engine for operation.

The present inventor has run a preliminary test of the system under controlled conditions, and has found that, before the installation of the supplementary filters, his stock automobile was capable of running an 18.5 second quarter-mile acceleration run. After the installation of the supplementary filter system, the quarter-mile acceleration time dropped to only 17.3 seconds, an improvement of nearly seven percent. This equates to an improvement in power output of better than fourteen percent, as acceleration varies as the square of the power, all other factors being equal. Further testing is expected to result in further improvements, as the system is optimized. It will be recognized that the improvements in power output may be applied to gains in fuel economy, as less fuel is required for any given amount of power due to the reduced pumping losses of the engine as a result of the engine induction system.

It is anticipated that the present engine induction system may be provided as an aftermarket kit for installation upon a wide variety of different automobiles, or even boats and certain aircraft (in accordance with applicable regulations). While the majority of applications of the system are anticipated to be on automobiles, it will be recognized that the present system may be applied to stationary powerplants as well, if so desired.

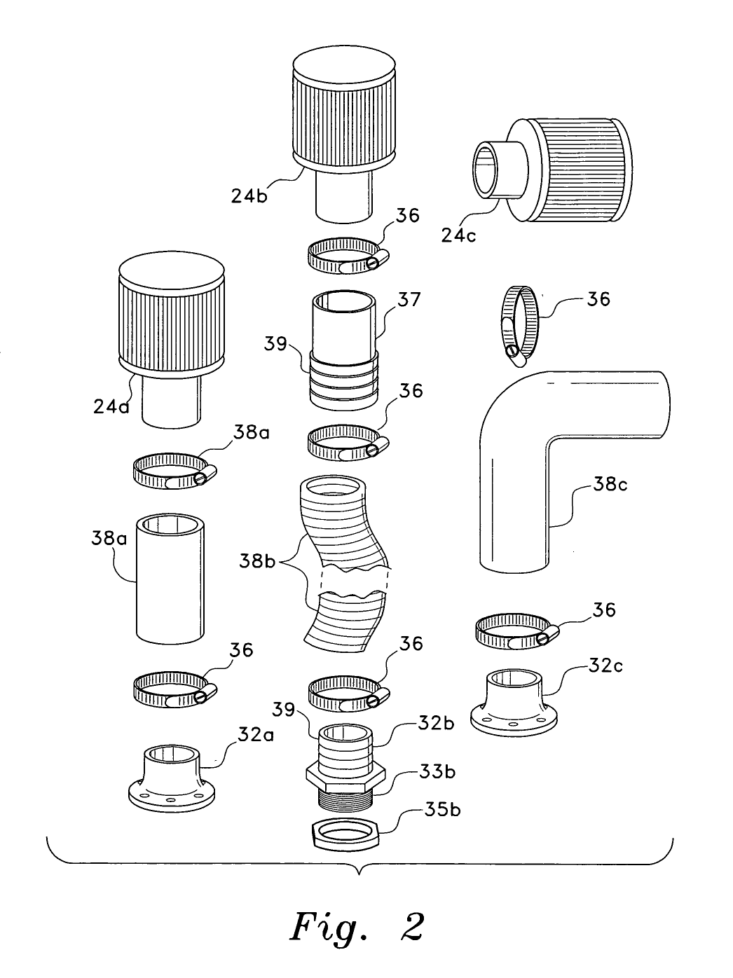

FIG. 2 illustrates an exemplary kit, which may be provided for an installation somewhat like that shown in the completed assembly of FIG. 1. In FIG. 2, the illustrated kit includes a group of three supplementary, secondary air filters 24a through 24c, a corresponding number of attachment fittings or flanges 32a through 32c, a corresponding number of supplementary filter connector tubes, respectively 38a through 38c, and an appropriate number of attachment clamps 36. The filters 24a through 24c are pictured as being identical to one another in FIGS. 1 and 2, but it will be recognized that they may be of different sizes and/or configurations from one another, depending upon the limitations of the installation environment. Much the same goes for the attachment tubes 38a through 38c, as well. For example, the first tube 38a may comprise a relatively short, rigid length of pipe or tube (stiff plastic, metal, etc.), where a relatively short run is desired between the first filter 24a and the plenum and where no bends or offset are required. The second tube 38b of FIG. 2 is essentially identical to the second tube 34b shown in FIG. 1, i.e., a relatively long length of SCAT tube or the like. Alternatively, the connector tube may comprise a rigid elbow, as in the third tube 38c shown in FIG. 2. Such a kit may be specifically engineered for specific placement of the supplemental filters 24a through 24c in specific locations in or adjacent to the engine compartment of a specific vehicle or other installation, or may be provided as a more generic kit with a length of flexible duct or tube for the installer to cut and route as required.

FIG. 2 also illustrates an alternative plenum attachment flange or fitting, comprising a tube 32b having a threaded plenum attachment end 33b which threads into a mating threaded collar or nut 35b. This assembly avoids the need to drill or otherwise form a series of small peripheral holes through the wall of the plenum for the attachment of flanges such as 32a and 32c, with their peripheral mounting holes. The threaded attachment end 33b of the tube 32b is inserted through a hole or passage in the plenum wall, and the collar or nut 35b is secured to the threaded portion 33b to lock the tube 32b in place on the plenum.

Another tubular fitting 37 is illustrated in FIG. 2, for connecting a length of flexible duct or hose (e.g., hose 38b) to the neck of a supplemental air filter (e.g., filter 24b). The fitting 37 has a generally cylindrical configuration, but includes a series of conical section barbs 39 surrounding the hose or tube insertion end in order to provide a more positive grip for the attachment clamp 36. The tube insertion end of the tube 32b is also provided with a series of similar conical section barbs 39, as shown in FIG. 2.

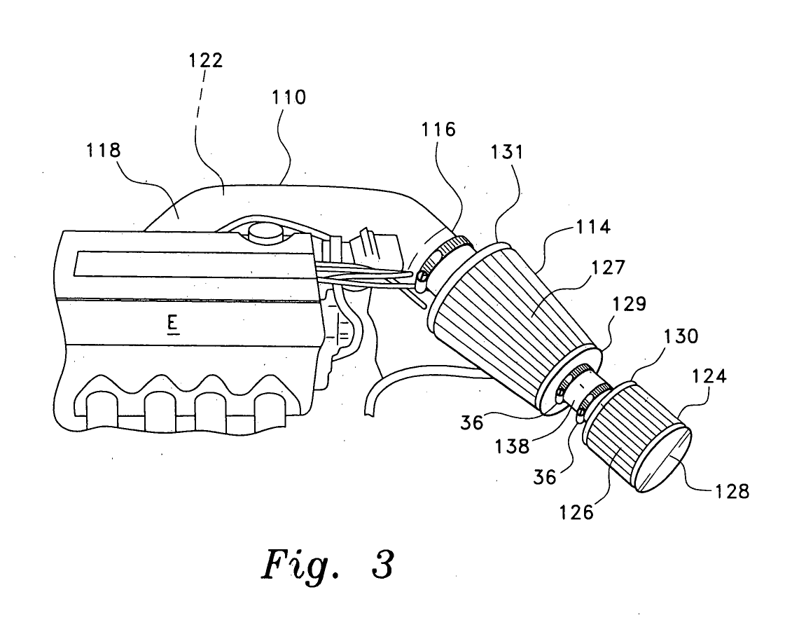

FIG. 3 of the drawings illustrates another embodiment of the engine induction system, wherein an aftermarket primary air filter 114 is installed externally to the air induction plenum 110 upon the single inlet 116 thereof, with a secondary, supplemental filter 124 installed in concert with the primary air filter 114. In FIG. 3, the air induction plenum 110 comprises a duct or the like which passes filtered induction airflow through its internal chamber 122 to an intake manifold (not shown) at its outlet end 118 for distribution to the cylinders of the engine E. Such plenums generally have an air filter housing or the like extending from their inlet ends 116, but such OEM housings may be removed for the installation of a different aftermarket air filter 114.

The aftermarket filter 114 illustrated in FIG. 3 has a toroidal filter element configuration with the circumferential filter element 127 having a truncated, generally conical configuration with a secondary air filter connection or inlet end 129 and an opposite open outlet end 131 connected to the inlet 116 of the plenum 110. The normally closed and sealed secondary filter connection and inlet end 129 of the primary filter 114 has been modified to provide a secondary air filter passage therethrough, with a flange similar to the attachment flanges 32a through 32c of FIGS. 1 and 2 (or other suitable attachment) installed on the secondary filter connection end 129 of the primary filter 114. The attachment end 130 of the secondary filter 124 is secured to the flange of the inlet end 129 of the primary filter 114 by an elongate connector tube 138 (which may comprise a relatively short length of tube, as shown in FIG. 3) and suitable clamps, e.g., hose clamps 36.

It will be recognized that plural secondary filters may be assembled end-to-end from the primary filter 114, if so desired, depending upon the amount of space available for the installation. The connector tube 138 may comprise a longer length than that shown in FIG. 3, and may be flexible or rigid, just as in the various embodiments 38a through 38c of FIG. 2. The tube 138 may also include one or more angular bends therein, to allow the secondary filter 124 to be positioned as desired, with the same principle applying to additional secondary filters attached to the first secondary or supplemental filter.

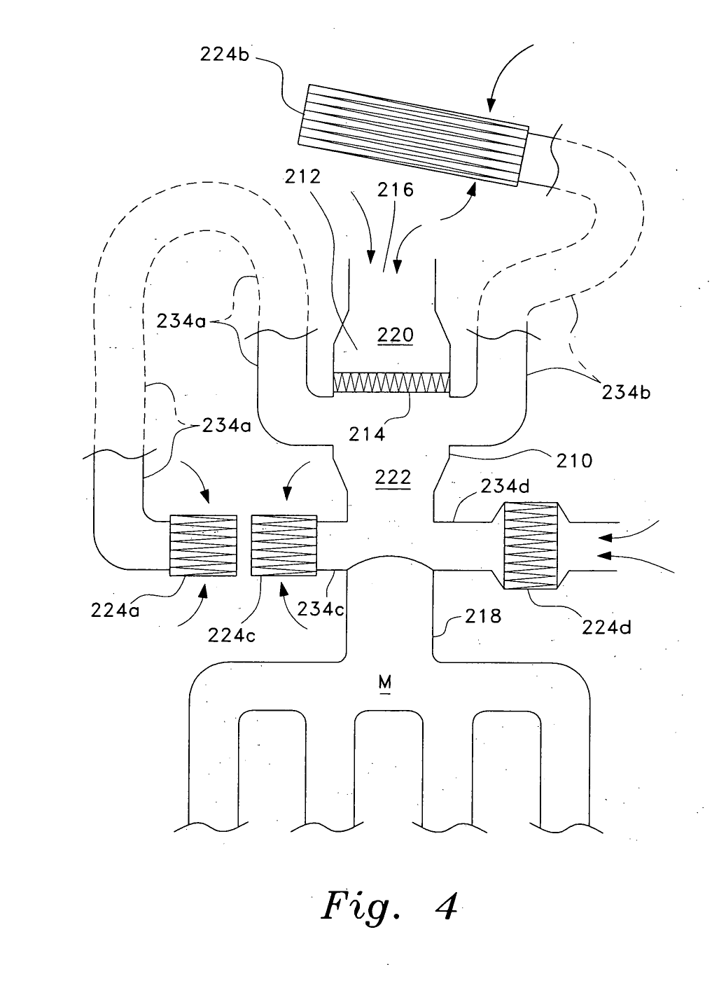

FIG. 4 is a schematic illustration of an exemplary induction system in accordance with the present invention. In FIG. 4, an engine air induction plenum 210 includes an internal chamber 212 having a primary filter 214 extending thereacross. The plenum 210 includes a single primary air inlet 216 and a single air outlet 218, which communicates with the engine intake manifold M. The primary air filter 214 separates the interior chamber 212 of the plenum 210 into an inlet cavity 220 to the upstream airflow side of the filter 214 and an outlet cavity 222 to the downstream side of the filter 214. This configuration is essentially the same as that illustrated in FIG. 1, and described further above.

A series of supplemental filters 224a, 224b, 224c, and 224d are connected to the outlet cavity 222 of the plenum 210, downstream of the primary filter 214. It will be recognized that there is no absolute numerical limitation on the number of supplemental or secondary filters which may be installed as a part of the present system, and the four shown in the schematic illustration of FIG. 4 are merely exemplary. The filters 224a through 224c have essentially the same configuration as the filters 24a through 24c and 124, i.e., a toroidal configuration defined by the circumferential filter element, with a closed end plate and opposite open plate connecting to the plenum 210. It will be noted, however, that the filter 224b is shown as having a considerably greater length than the two toroidal filters 224a and 224c. Such a relatively long and narrow filter 224b may provide certain packaging and installation advantages in certain motor vehicle and engine installations and configurations. It will be seen that any practicable filter shape may be constructed and used in the present invention as desired; the examples shown in FIG. 3, and other Figs., are not intended to be limiting in any manner.

The supplemental filter 224d is an inline unit much like the primary filter 214 within the plenum 210, with the filter 224d being captured or housed within a supplemental intake duct or between a supplemental air intake duct and the outlet cavity 222 of the plenum, the supplemental air intake duct directing incoming air through the filter 224d. Such a filter configuration may be used in lieu of any of the other supplemental filters described herein, depending upon the space available, the configuration of the installation, and other factors.

Each filter 224a through 224d is connected to the outlet cavity 222 of the plenum 210 downstream of the primary filter 214. The supplemental or secondary filter connections are by means of a corresponding number of tubes or ducts 234a through 234d. The various tubes or ducts 234a through 234d may have any suitable configuration, i.e., flexible duct or hose or rigid tube or pipe, either straight or angled, as required for the given installation.

The first and second ducts 234a and 234b comprise relatively long, convoluted units, as may be formed for positioning their supplemental air filters 224a and 224b at some location outside the engine compartment where cooler, more dense air is available for greater efficiency. The locations of the filters 224a and 224b shown in FIG. 4 are not to be considered as requirements for the system, but merely show that such supplemental filters may be positioned adjacent other supplemental filters, e.g., filter 224a shown closely adjacent filter 224c, or remotely from all other filters, e.g., 224b.

The third and fourth supplemental or secondary filters 224c and 224d extend from relatively short connector tubes or pipes 234c and 234d, which, in turn, extend outwardly from the outlet cavity 222 of the plenum 210 between the primary air filter 214 and the intake manifold M. Such connector tubes may be formed of rigid materials, e.g., plastic or metal, and may be straight or may be formed to any practicable curvature as required for the installation. The tubes 234c and 234d are shown as relatively short units merely to show that the lengths of the tubes are not critical. The third and fourth tubes may be made to be longer, sorter, or of the same length(s) as the other tubes 234a and/or 234b, as desired or required.

In conclusion, the present engine induction system serves to greatly improve the airflow into an internal combustion engine, thereby greatly improving its efficiency. The installation of all supplemental filters so that all air passing through the supplemental filter elements enters the induction system downstream of the primary filter, assures that the blockage of any of the filters will not block the induction system and cause an engine shutdown. Moreover, the present filters may be positioned in any practicable location, e.g., clear of the engine compartment where cooler and denser air is available, and/or at a relatively high or forward location to avoid road dust and spray, etc., as desired. While it is envisioned that the greatest market for the present induction system is for motor vehicles, the present system is by no means limited to such vehicles. Boats and/or aircraft (as permitted by regulation), and even stationary powerplants, will benefit from the installation of the present induction system. The present system has proven itself in preliminary experimental testing, and will prove to be a popular addition to many vehicles and engines. It is envisioned that the present system may be incorporated during original manufacture of a vehicle or engine system. However, the present system also lends itself as an aftermarket installation in either individual component form, or in kit form for installation by the professional shop or amateur mechanic.

It is to be understood that the present invention is not limited to the embodiments described above, but encompasses any and all embodiments within the scope of the following claims.

I claim:

1. An engine induction system, comprising:
an air induction plenum having a single inlet;
a single primary air filter disposed with said plenum; and
at least one secondary, supplemental air filter disposed externally to said plenum and communicating therewith.

2. The engine induction system according to claim 1, wherein said primary air filter comprises a flat filter element disposed within said plenum.

3. The engine induction system according to claim 1, wherein:
said primary air filter has a generally toroid configuration with a circumferential filter element, a secondary air filter connection end, and an open outlet end opposite the secondary air filter connection end;
said primary air filter is disposed externally to said plenum, with the outlet end of said primary air filter being connected to the inlet of said plenum; and
said at least one secondary, supplemental air filter is connected to the secondary air filter connection end of said primary air filter.

4. The engine induction system according to claim 1, wherein said at least one secondary, supplemental air filter comprises a plurality of air filters.

5. The engine induction system according to claim 1, further including an elongate tube disposed between said at least one secondary, supplemental air filter and said plenum.

6. The engine induction system according to claim 5, wherein said elongate tube is selected from tubes consisting of flexible hose and rigid pipe.

7. The engine induction system according to claim 1, wherein said at least one secondary, supplemental air filter has a generally toroid configuration with a circumferential filter element, a closed end, and an open outlet end opposite said closed end.

8. The engine induction system according to claim 1, further comprising a kit including at least one secondary, supplemental air filter, at least one connector tube, at least one connector tube attachment component, and at least one pair of connector clamps.

9. An engine induction system, comprising:
an air induction plenum having an inlet and an outlet opposite the inlet, the plenum defining an internal chamber;
a primary air filter disposed within said plenum, dividing the internal volume into an inlet portion and an outlet portion; and
at least one secondary, supplemental air filter disposed externally to said plenum and communicating with the outlet portion of said plenum.

10. The engine induction system according to claim 9, wherein said at least one secondary, supplemental air filter comprises a plurality of air filters.

11. The engine induction system according to claim 9, further including an elongate tube disposed between said at least one secondary, supplemental air filter and said plenum.

12. The engine induction system according to claim 11, wherein said elongate tube is selected from tubes consisting of flexible hose and rigid pipe.

13. The engine induction system according to claim 9, wherein said at least one secondary, supplemental air filter has a generally toroid configuration with a circumferential filter element, a closed end, and an open outlet end opposite said closed end.

14. The engine induction system according to claim 9, further comprising a kit including at least one secondary, supplemental air filter, at least one connector tube, at least one connector tube attachment component, and at least one pair of connector clamps.

15. An engine induction system, comprising:
an air induction plenum having an inlet and an outlet opposite the inlet, the plenum defining an internal chamber;
a primary air filter having a generally toroidal configuration with a circumferential filter element, a secondary air filter connection end, and an open outlet end opposite the secondary air filter connection end;
said primary air filter being disposed externally to said plenum, the outlet end of said primary air filter being connected to the inlet of said plenum; and
said at least one secondary, supplemental air filter being connected to the secondary air filter connection end of said primary air filter.

16. The engine induction system according to claim 15, wherein said at least one secondary, supplemental air filter comprises a plurality of air filters.

17. The engine induction system according to claim 15, further including an elongate tube disposed between said at least one secondary, supplemental air filter and said plenum.

18. The engine induction system according to claim 17, wherein said elongate tube is selected from tubes consisting of flexible hose and rigid pipe.

19. The engine induction system according to claim 15, wherein said at least one secondary, supplemental air filter has a generally toroid configuration with a circumferential filter element, a closed end, and an open outlet end opposite said closed end.

20. The engine induction system according to claim 15, further comprising a kit including at least one secondary, supplemental air filter, at least one connector tube, at least one connector tube attachment component, and at least one pair of connector clamps.
